(19) United States
(12) Patent Application Publication
(10) Pub. No.: US 2026/0291402 A1
(43) Pub. Date: Sep. 24, 2026

(54) CONTROL METHOD FOR POWER CONVERTER AND POWER CONVERSION DEVICE

(71) Applicant: Delta Electronics, Inc., Taoyuan City (TW)

(72) Inventors: Fan Zhang, Shanghai (CN); Yueyong Meng, Shanghai (CN); Xinghua Pei, Shanghai (CN); Hui Ding, Shanghai (CN); Haixin Wu, Shanghai (CN)

(21) Appl. No.: 19/556,074

(22) Filed: Mar. 4, 2026

(30) Foreign Application Priority Data
Mar. 19, 2025 (CN) 202510326883.3

(51) Int. Cl. H02M 7/217; H02M 1/44

(52) U.S. Cl. CPC H02M 7/217; H02M 1/44

(57) ABSTRACT

A control method for a power converter is provided. The power converter includes a filtering module, an inductor and a switching circuit. The control method includes steps of: providing a voltage loop unit, detecting an output voltage from the power converter, and outputting a voltage compensation signal according to the output voltage and a voltage reference signal; providing a multi-stage high-frequency filter, receiving a voltage signal from the filtering module, and outputting a filtered signal; providing a current compensation module, receiving the voltage signal from the filtering module, an inductor current flowing through the inductor and the voltage compensation signal, and outputting a current compensation signal; superimposing the filtered signal and the current compensation signal to obtain a first control signal; and providing a driving module, receiving the first control signal and correspondingly outputting a second control signal to control at least one switch of the switching circuit.

### CROSS-REFERENCE TO RELATED APPLICATIONS

This application claims priority to China Patent Application No. 202510326883.3 filed on Mar. 19, 2025. The entire contents of the above-mentioned patent application are incorporated herein by reference for all purposes.

### FIELD OF THE INVENTION

The present disclosure relates to a power converter, and more particularly to a control method for a power converter and a power conversion device using the control method.

### BACKGROUND OF THE INVENTION

A weak power grid refers to the areas or parts of the power system where voltage stability is poor and voltage fluctuations are significant. These areas may experience large voltage fluctuations and voltage deviations from the normal operating range because of load variations, incomplete grid topology, insufficient power supply, or other possible factors. In these areas, various measures are usually needed to improve the grid stability while ensuring the proper operation of power converters and the safety of user equipment.

Nowadays, a first solution for the weak grids in power conversion devices is a recognition method. In accordance with the recognition method, the current in the power conversion device is sampled and filtered, or characteristic quantities (e.g., the amplitude of the current in a specified frequency band) are extracted to determine in real time whether the system is in a weak grid condition. If a weak grid condition is detected, the extracted characteristic quantities are analyzed, and pre-configured parameters are selected according to the analysis results. However, the recognition method requires a certain time delay to ensure accurate judgment and may also result in misjudgments of the weak grid condition because of waveform distortion in the grid voltage.

A second solution for the weak grids in power conversion devices is a grid voltage feedforward control method. In accordance with the grid voltage feedforward control method, the grid voltage feedforward is processed to enable compatible with both weak and normal grid conditions. Consequently, the needs for the identification operation and the switching operations required in the recognition method will be avoided. In addition, the background harmonics in the grid voltage will be suppressed, and the dynamic response capability of the grid will be enhanced. However, the existing grid voltage feedforward control method sacrifices harmonic suppression performance in the normal grid conditions to ensure stable operation in the weak grid conditions. In other words, the grid voltage feedforward control method used in the power conversion devices cannot be effectively compatible with both normal and weak grids.

In order to overcome the drawbacks of the conventional technologies, it is important to provide a control method for a power converter and a power conversion device using the control method.

### SUMMARY OF THE INVENTION

The present disclosure provides a control method for a power converter and a power conversion device using the control method.

In accordance with an aspect of the present disclosure, a control method for a power converter is provided. The power converter is electrically connected with a grid. The power converter includes a filtering module, a first inductor and a switching circuit. The filtering module and the gird are connected with each other in parallel. A series connection structure of the switching circuit and the first inductor are connected with the filtering module in parallel. The control method includes following steps. Firstly, a voltage loop unit is provided, and the voltage loop unit is electrically connected with an output terminal of the power converter. The voltage loop unit detects an output voltage from the power converter, and the voltage loop unit outputs a voltage compensation signal according to the output voltage and a first voltage reference signal. Then, a multi-stage high-frequency filter is provided, and the multi-stage high-frequency filter is electrically connected with the filtering module. The multi-stage high-frequency filter receives and filters a voltage signal from the filtering module, and the multi-stage high-frequency filter outputs a filtered signal. Then, a current compensation module is provided, and the current compensation module is electrically connected with the filtering module, the first inductor and the voltage loop unit. The current compensation module receives the voltage signal from the filtering module, an inductor current flowing through the first inductor and the voltage compensation signal, and the current compensation module outputs a current compensation signal. Then, the filtered signal and the current compensation signal are superimposed, so that a first control signal is obtained. Then, a driving module is provided, and the driving module is electrically connected with the multi-stage high-frequency filter, the current compensation module and the switching circuit. The driving module receives the first control signal and correspondingly outputs a second control signal. A duty cycle of at least one switch in the switching circuit is controlled according to the second control signal.

In accordance with an aspect of the present disclosure, a power conversion device is provided. The power conversion device includes a power converter and a control unit. The power converter is electrically connected with a power grid. The power converter includes a filtering module, a first inductor and a switching circuit. The filtering module is connected with the power grid in parallel. A series connection structure of the switching circuit and the first inductor is connected with the filtering module in parallel. The control unit includes a voltage loop unit, a multi-stage high-frequency filter, a current compensation module and a driving module. The voltage loop unit is electrically connected with an output terminal of the power converter. The voltage loop unit detects an output voltage from the power converter, and the voltage loop unit outputs a voltage compensation signal according to the output voltage and a first voltage reference signal. The multi-stage high-frequency filter is electrically connected with the filtering module. The multi-stage high-frequency filter receives and filters a voltage signal from the filtering module, and the multi-stage high-frequency filter outputs a filtered signal. The current compensation module is electrically connected with the filtering module, the first inductor and the voltage loop unit. The current compensation module receives the voltage signal from the filtering module, an inductor current flowing through the first inductor and the voltage compensation signal, and the current compensation module outputs a current compensation signal. The driving module is electrically connected with the multi-stage high-frequency filter, the current compensation module and the switching circuit. The driving module receives a first control signal and correspondingly outputs a second control signal. The filtered signal and the current compensation signal are superimposed with each other, so that the first control signal is obtained. A duty cycle of at least one switch in the switching circuit is controlled according to the second control signal.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a flowchart of a control method according to an embodiment of the present disclosure;

FIG. 2 is a schematic circuit diagram illustrating the circuitry topology of a power conversion device using the control method of FIG. 1;

FIG. 3 is a schematic circuit diagram illustrating the detailed circuitry topology of the power conversion device shown in FIG. 2;

FIG. 4A is a current simulation diagram illustrating a current at an input terminal of a conventional power converter using a grid voltage feedforward control mechanism with a single-phase phase-locked loop as the feedforward;

FIG. 4B is a current simulation diagram illustrating a current at an input terminal of the conventional power converter using the grid voltage feedforward control mechanism with a first-order low-pass filter as the feedforward;

FIG. 4C is a current simulation diagram illustrating a current at an input terminal of the present power conversion device using a grid voltage feedforward control with a high-stage high-frequency filter as the feedforward;

FIG. 5A is a current harmonic spectrum analysis diagram illustrating the conventional power converter using the grid voltage feedforward control mechanism with the single-phase phase-locked loop as the feedforward;

FIG. 5B is a current harmonic spectrum analysis diagram illustrating the conventional power converter using the grid voltage feedforward control mechanism with a first-order low-pass filter as the feedforward; and

FIG. 5C is a current harmonic spectrum analysis diagram illustrating the present power conversion device using the grid voltage feedforward control with a high-stage high-frequency filter as the feedforward.

### DETAILED DESCRIPTION OF THE PREFERRED EMBODIMENT

The present disclosure will now be described more specifically with reference to the following embodiments. It is noted that the following descriptions of the preferred embodiments of the present disclosure are presented herein for purpose of illustration and description only. It is not intended to be exhaustive or to be limited to the precise from disclosed.

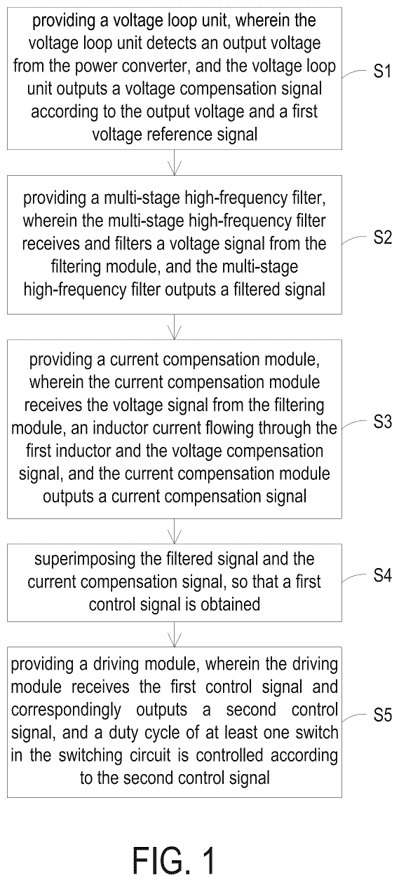

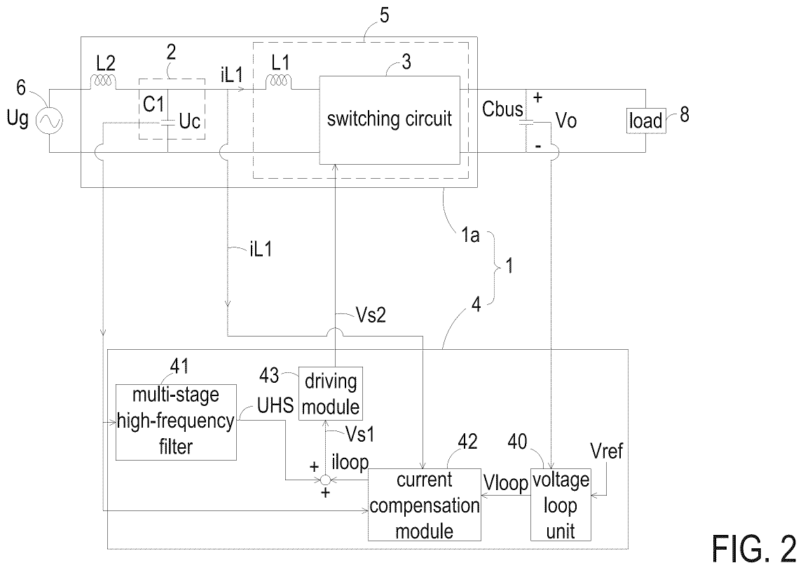

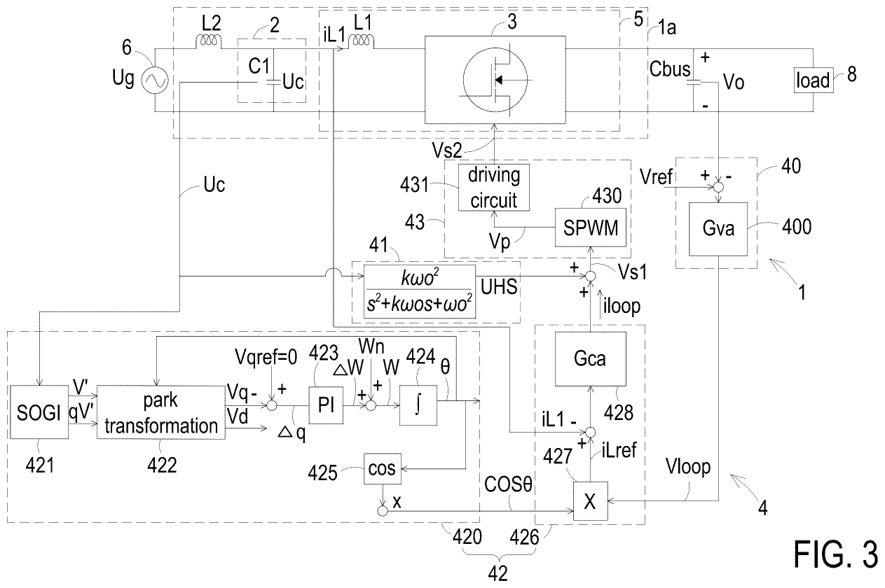

Please refer to FIGS. 1, 2 and 3. FIG. 1 is a flowchart of a control method according to an embodiment of the present disclosure. FIG. 2 is a schematic circuit diagram illustrating the circuitry topology of a power conversion device using the control method of FIG. 1. FIG. 3 is a schematic circuit diagram illustrating the detailed circuitry topology of the power conversion device shown in FIG. 2. The control method of the present disclosure can be applied to a power converter 1a of a power conversion device 1 shown in FIG. 2.

The input terminal of the power conversion device 1 is electrically connected with a power grid 6 to receive an input voltage Ug from the power grid 6. The output terminal of the power converter 1a is electrically connected with a load 8. The input voltage Ug is converted into an output voltage Vo by the power converter 1a. The output voltage Vo is outputted from the output terminal of the power converter 1a. In an embodiment, the power conversion device 1 includes the power converter 1a and a control unit 4. The operations of the power converter 1a are controlled by the control unit 4.

The power converter 1a includes a filtering module 2, a first inductor L1 and a switching circuit 3. The filtering module 2 is electrically connected with the input terminal of the power converter 1a. In addition, the filtering module 2 is electrically connected with the power grid 6 in parallel through the input terminal of the power converter 1a. After the input voltage Ug is filtered by filtering module 2, a capacitor voltage Uc is generated. Preferably but not exclusively, the filtering module 2 includes a filtering capacitor C1. The first inductor L1 is electrically connected with the switching circuit 3 in series. In addition, the series connection structure of the switching circuit 3 and the first inductor L1 is further connected with the filtering module 2 in parallel. The switching circuit 3 is electrically connected with the output terminal of the power converter 1a. The switching circuit 3 includes at least one switch. The switching circuit 3 receives the capacitor voltage Uc through the first inductor L1. In response to the switching action of the at least one switch, the capacitor voltage Uc is converted into the output voltage Vo, and the output voltage Vo is outputted to the output terminal of the power converter 1a.

The control unit 4 is electrically connected with the switching circuit 3, the first inductor L1 and the filtering module 2 to detect respective operation parameters of the filtering module 2, the first inductor L1 and the switching circuit 3. The switching action of the switching circuit 3 is determined according to the detecting results. Preferably but not exclusively, the operation parameters include the capacitor voltage Uc of the filtering capacitor C1 in the filtering module 2, an inductor current iLl flowing through the first inductor L1 and the output voltage Vo from the switching circuit 3. In an embodiment, the control unit 4 includes a voltage loop unit 40, a multi-stage high-frequency filter 41, a current compensation module 42 and a driving module 43.

The voltage loop unit 40 is electrically connected with the output terminal of the power converter 1a. The voltage loop unit 40 detects the output voltage Vo from the power converter 1a, and the voltage loop unit 40 outputs a voltage compensation signal Vloop according to the output voltage Vo and a first voltage reference signal Vref.

The multi-stage high-frequency filter 41 is electrically connected with the filtering module 2. The multi-stage high-frequency filter 41 receives and filters a voltage signal from the filtering module 2, and the multi-stage high-frequency filter 41 outputs a filtered signal UHS. For example, the voltage signal is the capacitor voltage Uc of the filtering capacitor C1.

The current compensation module 42 is electrically connected with the filtering module 2, the first inductor L1 and the voltage loop unit 40. The current compensation module 42 receives the voltage signal (i.e., the capacitor voltage Uc of the filtering capacitor C1) from the filtering module 2, the inductor current iLl flowing through the first inductor L1 and the voltage compensation signal Vloop, and the current compensation module 42 outputs a current compensation signal iloop.

Furthermore, the filtered signal UHS and the current compensation signal iloop are superimposed with each other. Consequently, a first control signal Vs1 is obtained.

The driving module 43 is electrically connected with the multi-stage high-frequency filter 41, the current compensation module 42 and the switching circuit 3. The driving module 43 receives the first control signal Vs1 and correspondingly outputs a second control signal Vs2. The switching action of the at least one switch in the switching circuit 3 is controlled according to the second control signal Vs2. For example, the duty cycle of the at least one switch in the switching circuit 3 is controlled according to the second control signal Vs2.

Please refer to FIG. 1 again. The control method includes the following steps.

In a step S1, the voltage loop unit 40 is provided. The voltage loop unit 40 is electrically connected with the output terminal of the power converter 1a. The voltage loop unit 40 detects the output voltage Vo from the power converter 1a, and the voltage loop unit 40 outputs the voltage compensation signal Vloop according to the output voltage Vo and the first voltage reference signal Vref.

In a step S2, the multi-stage high-frequency filter 41 is provided. The multi-stage high-frequency filter 41 is electrically connected with the filtering module 2. The multi-stage high-frequency filter 41 receives and filters the voltage signal from the filtering module 2. Consequently, the multi-stage high-frequency filter generates the filtered signal UHS.

In a step S3, the current compensation module 42 is provided. The current compensation module 42 is electrically connected with the filtering module 2, the first inductor L1 and the voltage loop unit 40. The current compensation module 42 receives the voltage signal from the filtering module 2, the inductor current iL 1 flowing through the first inductor L1 and the voltage compensation signal Vloop. In addition, the current compensation module 42 outputs the current compensation signal iloop.

In a step S4, the filtered signal UHS and the current compensation signal iloop are superimposed, and thus the first control signal Vs1 is obtained.

In a step S5, the driving module 43 is provided. The driving module 43 is electrically connected with the multi-stage high-frequency filter 41, the current compensation module 42 and the switching circuit 3. The driving module 43 receives the first control signal Vs1 and correspondingly outputs the second control signal Vs2. Furthermore, the duty cycle of the at least one switch in the switching circuit 3 is controlled according to the second control signal Vs2.

From the above descriptions, the control method of the present disclosure adopts a grid voltage feedforward control mechanism.

Consequently, the needs for the identification and switching operations required in conventional recognition methods are omitted. Furthermore, since the background harmonics in the grid voltage are suppressed, the dynamic response capability of the grid is enhanced. Moreover, the control method of the present disclosure additionally uses the multi-stage high-frequency filter in the grid voltage feedforward control mechanism for achieving the filtering purpose. As a result, the control method of the present disclosure can effectively retain low-frequency signals and filter out high-frequency disturbances. In this way, the performance of suppressing background harmonics of the grid voltage is enhanced.

In an embodiment, the voltage loop unit 40 includes a first proportional-integral regulator 400. As shown in FIG. 3, the first proportional-integral regulator 400 has a transfer function Gva. The first proportional-integral regulator 400 is electrically connected with the output terminal of the power converter 1a. The first proportional-integral regulator 400 detects the output voltage Vo from the power converter 1a, and the first proportional-integral regulator 400 outputs the voltage compensation signal Vloop according to the output voltage Vo and the first voltage reference signal Vref.

In an embodiment, the current compensation module 42 includes a phase-locked loop unit 420. The phase-locked loop unit 420 is electrically connected with the filtering module 2. The phase-locked loop unit 420 receives the voltage signal from the filtering module 2, and the phase-locked loop unit 420 correspondingly outputs a phase angle θ and a cosine signal cosθ.

The phase-locked loop unit 420 includes a first integrator 421, a coordinate transformation unit 422, a second proportional-integral regulator 423, a second integrator 424 and a first calculating unit 425, which are electrically connected with each other in sequence. As shown in FIG. 3, the first integrator 421 is a second-order generalized integrator (SOGI). The voltage signal from the filtering module 2 is converted into a set of orthogonal signals V′ and qV by the first integrator 421. As shown in FIG. 3, the coordinate transformation unit 422 use park transformation (Park) to perform the coordinate transformation. The set of orthogonal signals V′ and qV′ are converted into a d-axis voltage signal Vd and a q-axis voltage signal Vq by the coordinate transformation unit 422 according to the phase angle signal θ. The second proportional-integral regulator 423, marked as PI in FIG. 3, may be, but is not limited to, a proportional-integral regulator. The second proportional-integral regulator 423 receives the q-axis voltage signal Vq and a second voltage reference signal Vqref. In addition, the second proportional-integral regulator 423 correspondingly outputs a frequency offset ΔW according to a difference value between the q-axis voltage signal Vq and the second voltage reference signal Vqref. The second integrator 424, marked as § in FIG. 3, is used to perform the integrating calculation. The second integrator 424 receives the frequency offset ΔW and a nominal frequency Wn. The second integrator 424 correspondingly outputs the phase angle signal θ according to the superimposed value W of the frequency offset ΔW and a nominal frequency Wn. The calculating unit 425, marked as COS in FIG. 3, is used to generate the cosine signal cosθ. The first calculating unit 425 generates the cosine signal cosθ according to the phase angle signal θ, wherein the amplitude of the cosine signal cosθ is 1.

In an embodiment, the current compensation module 42 includes a current loop unit 426. The current loop unit 426 includes a multiplier 427 and a third proportional-integral regulator 428, which are electrically connected with each other in sequence. The multiplier 427, marked as X in FIG. 3, is used to perform the multiplication calculation. The multiplier 427 is electrically connected with the calculating unit 425 and the voltage loop unit 40. The multiplier 427 multiplies the cosine signal cosθ and the voltage compensation signal Vloop to obtain the current reference signal iLref. The third proportional-integral regulator 428 has a transfer function Gca. The third proportional-integral regulator 428 is electrically connected with the first inductor L1. The third proportional-integral regulator 428 receives the current reference signal iLref and the inductor current iLl and correspondingly outputs the current compensation signal iloop.

In an embodiment, the driving module 43 includes a modulation circuit 430 and a driving circuit 431. The modulation circuit 430 is used to perform a sinusoidal pulse width modulation (SWPM). The modulation circuit 430 is electrically connected with the current compensation module 42 and the multi-stage high-frequency filter 41. The modulation circuit 430 receives the first control signal Vs1 and correspondingly outputs a modulation signal Vp. The driving circuit 431 is electrically connected with the modulation circuit 430 and the switching circuit 3. The driving circuit 431 receives the modulation signal Vp and correspondingly outputs the second control signal Vs2 to control the switching operation of each switch of the switching circuit 3.

In an embodiment, the power converter 1a includes a power factor correction circuit 5. The power factor correction circuit 5 includes the first inductor L1 and the switching circuit 3. The multi-stage high-frequency filter 41 includes a second-order generalized integrator. Preferably but not exclusively, the cutoff frequency of the second-order generalized integrator is 1500 Hz. As shown in FIG. 3, the transfer function of the multi-stage high-frequency filter 41 is

$$\frac{k ω {o}^{2}}{{s}^{2} + k ω os + ω {o}^{2}} ,$$

wherein ω is the resonant angular frequency, K is the gain value, and s is the complex frequency variable.

In some other embodiments, the output terminal of the power converter 1a of the power conversion device 1 is electrically connected with a bus capacitor Cbus in parallel. In some embodiments, the power converter 1a further includes a second inductor L2. The second inductor L2 is electrically connected between the input terminal of the power converter 1a and the first inductor L1.

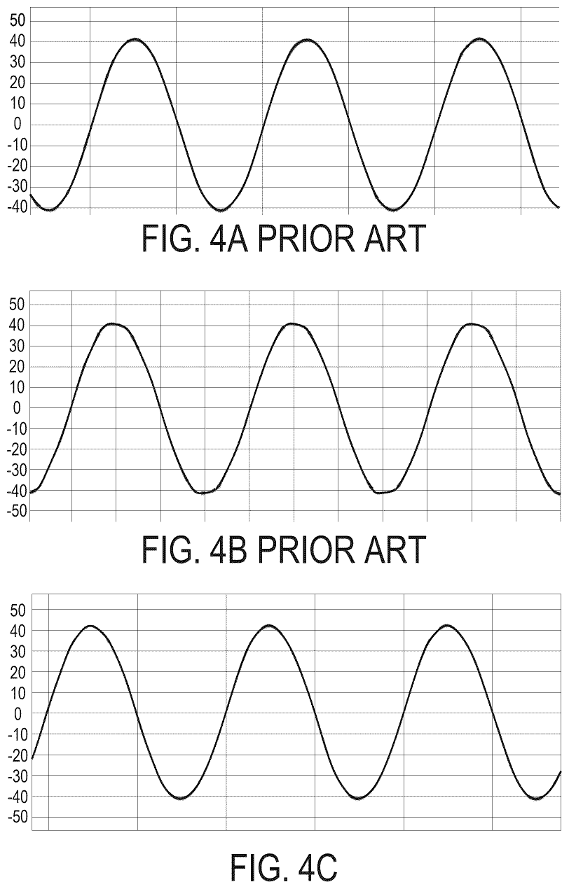

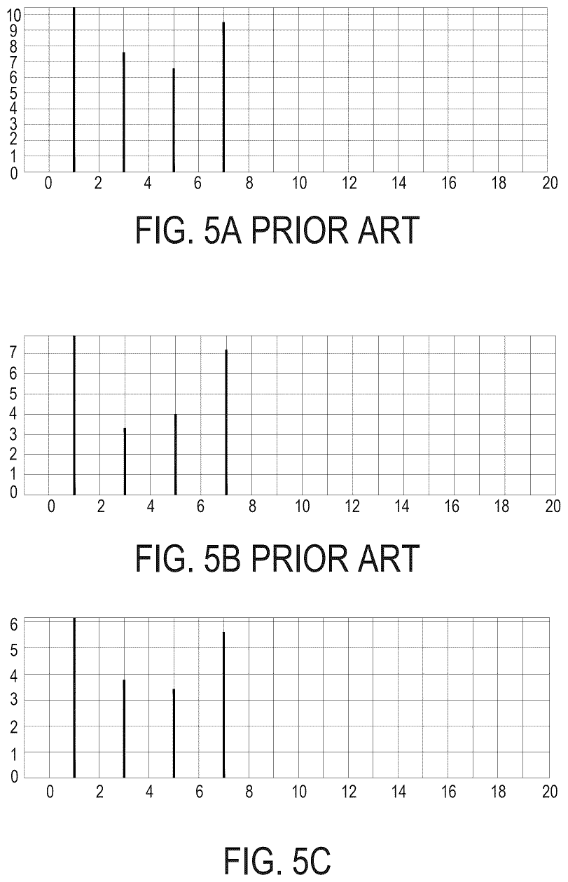

Please refer to FIGS. 4A, 4B, 4C, 5A, 5B and 5C. FIG. 4A is a current simulation diagram illustrating a current at an input terminal of a conventional power converter using a grid voltage feedforward control mechanism with a single-phase phase-locked loop as the feedforward. FIG. 4B is a current simulation diagram illustrating a current at an input terminal of the conventional power converter using the grid voltage feedforward control mechanism with a first-order low-pass filter as the feedforward. FIG. 4C is a current simulation diagram illustrating a current at an input terminal of the present power conversion device using a grid voltage feedforward control with a high-stage high-frequency filter as the feedforward. FIG. 5A is a current harmonic spectrum analysis diagram illustrating the conventional power converter using the grid voltage feedforward control mechanism with the single-phase phase-locked loop as the feedforward. FIG. 5B is a current harmonic spectrum analysis diagram illustrating the conventional power converter using the grid voltage feedforward control mechanism with a first-order low-pass filter as the feedforward. FIG. 5C is a current harmonic spectrum analysis diagram illustrating the present power conversion device using the grid voltage feedforward control with a high-stage high-frequency filter as the feedforward.

In FIGS. 4A, 4B and 4C, the simulation conditions include: the inductance value of the first inductor L1 is 150 μH, the inductance value of the second inductor L2 is 2 mH, the capacitance value of the filter capacitor is 13.2 μF, the input voltage Vin is 220 Vrms, and the power of the power conversion device 1 is 6000 W. In FIG. 4B, a first-order low-pass filter is used as the grid voltage feedforward part, and the current shows noticeable distortion. In FIG. 4A, a single-phase phase-locked loop is used as the grid voltage feedforward part. In FIG. 4C, a multi-stage high-frequency filter is used as the grid voltage feedforward part. The simulation results of FIG. 4A and FIG. 4C indicate that the current waveforms are more sinusoidal.

In FIGS. 5A, 5B, and 5C. Under the normal grid conditions, the grid voltage background harmonics are set to 10% for the third harmonic, and 5% each for the fifth and seventh harmonics. Furthermore, the simulation conditions include: the inductance value of the first inductor L1 is 150 μH, the inductance value of the second inductor L2 is 0, the capacitance value of the filter capacitor C1 is 13.2 μF, the input voltage Vin is 220 Vrms, and the power of the power conversion device is 6000 W. In FIG. 5A, a single-phase phase-locked loop is used as the grid voltage feedforward part in FIG. 5A, and the simulation results shows that it has almost no capability to suppress the background harmonics. In FIG. 5B, a first-order low-pass filter is used as the grid voltage feedforward part. In FIG. 5C, the multi-stage high-frequency filter 41 is used as the grid voltage feedforward parts. The simulation results of FIG. 5A and FIG. 5C indicate that both can suppress the background harmonics. In addition, the use of the multi-stage high-frequency filter 41 provides significantly better performance of suppressing background harmonics when compared with the use of the first-order low-pass filter.

From the above descriptions, the control method of the present disclosure adopts a grid voltage feedforward control mechanism. Consequently, the needs for the identification and switching operations required in conventional recognition methods are omitted. Furthermore, since the background harmonics in the grid voltage are suppressed, the dynamic response capability of the grid is enhanced. Moreover, the control method of the present disclosure additionally uses the multi-stage high-frequency filter in the grid voltage feedforward control mechanism for achieving the filtering purpose. As a result, the control method of the present disclosure can effectively retain low-frequency signals and filter out high-frequency disturbances. In this way, the performance of suppressing background harmonics of the grid voltage is enhanced.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A control method for a power converter, the power converter being electrically connected with a power grid, the power converter comprising a filtering module, a first inductor and a switching circuit, the filtering module and the gird being connected with each other in parallel, a series connection structure of the switching circuit and the first inductor being connected with the filtering module in parallel, the control method comprising steps of:
providing a voltage loop unit, wherein the voltage loop unit is electrically connected with an output terminal of the power converter, wherein the voltage loop unit detects an output voltage from the power converter, and the voltage loop unit outputs a voltage compensation signal according to the output voltage and a first voltage reference signal;
providing a multi-stage high-frequency filter, wherein the multi-stage high-frequency filter is electrically connected with the filtering module, wherein the multi-stage high-frequency filter receives and filters a voltage signal from the filtering module, and the multi-stage high-frequency filter outputs a filtered signal;
providing a current compensation module, wherein the current compensation module is electrically connected with the filtering module, the first inductor and the voltage loop unit, wherein the current compensation module receives the voltage signal from the filtering module, an inductor current flowing through the first inductor and the voltage compensation signal, and the current compensation module outputs a current compensation signal;
superimposing the filtered signal and the current compensation signal, so that a first control signal is obtained; and
providing a driving module, wherein the driving module is electrically connected with the multi-stage high-frequency filter, the current compensation module and the switching circuit, wherein the driving module receives the first control signal and correspondingly outputs a second control signal, and a duty cycle of at least one switch in the switching circuit is controlled according to the second control signal.

2. The control method according to claim 1, wherein the voltage loop unit comprises a first proportional-integral regulator, and the first proportional-integral regulator is electrically connected with the output terminal of the power converter, wherein the first proportional-integral regulator detects the output voltage from the power converter, and the first proportional-integral regulator outputs the voltage compensation signal according to the output voltage and the first voltage reference signal.

3. The control method according to claim 1, wherein the current compensation module comprises a phase-locked loop unit, and the phase-locked loop unit is electrically connected with the filtering module, wherein the phase-locked loop unit receives the voltage signal from the filtering module, and the phase-locked loop unit correspondingly outputs a phase angle signal and a cosine signal.

4. The control method according to claim 3, wherein the phase-locked loop unit comprises a first integrator, a coordinate transformation unit, a second proportional-integral regulator, a second integrator and a first calculating unit, which are electrically connected with each other in sequence,
wherein the voltage signal from the filtering module is converted into a set of orthogonal signals by the first integrator,
wherein the set of the orthogonal signals are converted into a d-axis voltage signal and a q-axis voltage signal by the coordinate transformation unit according to the phase angle signal,
wherein the second proportional-integral regulator receives the q-axis voltage signal and a second reference signal and correspondingly outputs a frequency offset,
wherein the second integrator receives the frequency offset and a nominal frequency and correspondingly outputs a phase angle signal, and
wherein the first calculating unit generates the cosine signal according to the phase angle signal, wherein an amplitude of the cosine signal is 1.

5. The control method according to claim 4, wherein the current compensation module further comprises a current loop unit, and the current loop unit comprises a multiplier and a third proportional-integral regulator, which are electrically connected with each other in sequence, wherein the multiplier multiplies the cosine signal and the voltage compensation signal to obtain a current reference signal, and the third proportional-integral regulator receives the current reference signal and the inductor current and correspondingly outputs the current compensation signal.

6. The control method according to claim 1, wherein the driving module comprises a modulation circuit and a driving circuit, wherein the modulation circuit is electrically connected with the current compensation module and the multi-stage high-frequency filter, and the modulation circuit receives the first control signal and correspondingly outputs a modulation signal, wherein the driving circuit is electrically connected with the modulation circuit and the switching circuit, and the driving circuit receives the modulation signal and correspondingly outputs the second control signal.

7. The control method according to claim 1, wherein the power converter comprises a power factor correction circuit, and the power factor correction circuit comprises the first inductor and the switching circuit.

8. The control method according to claim 1, wherein the multi-stage high-frequency filtering comprises a second-order generalized integrator.

9. The control method according to claim 1, wherein the filtering module comprises a filtering capacitor.

10. The control method according to claim 1, wherein the output terminal of the power converter is connected with a bus capacitor in parallel.

11. A power conversion device, comprising:
a power converter electrically connected with a power grid, wherein the power converter comprises a filtering module, a first inductor and a switching circuit, wherein the filtering module is connected with the power grid in parallel, and a series connection structure of the switching circuit and the first inductor is connected with the filtering module in parallel; and
a control unit comprising:
a voltage loop unit electrically connected with an output terminal of the power converter, wherein the voltage loop unit detects an output voltage from the power converter, and the voltage loop unit outputs a voltage compensation signal according to the output voltage and a first voltage reference signal;
a multi-stage high-frequency filter electrically connected with the filtering module, wherein the multi-stage high-frequency filter receives and filters a voltage signal from the filtering module, and the multi-stage high-frequency filter outputs a filtered signal;
a current compensation module electrically connected with the filtering module, the first inductor and the voltage loop unit, wherein the current compensation module receives the voltage signal from the filtering module, an inductor current flowing through the first inductor and the voltage compensation signal, and the current compensation module outputs a current compensation signal; and
a driving module electrically connected with the multi-stage high-frequency filter, the current compensation module and the switching circuit, wherein the driving module receives a first control signal and correspondingly outputs a second control signal, wherein the filtered signal and the current compensation signal are superimposed with each other, so that the first control signal is obtained, wherein a duty cycle of at least one switch in the switching circuit is controlled according to the second control signal.

12. The power conversion device according to claim 11, wherein the voltage loop unit comprises a first proportional-integral regulator, and the first proportional-integral regulator is electrically connected with the output terminal of the power converter, wherein the first proportional-integral regulator detects the output voltage from the power converter, and the first proportional-integral regulator outputs the voltage compensation signal according to the output voltage and the first voltage reference signal.

13. The power conversion device according to claim 11, wherein the current compensation module comprises a phase-locked loop unit, and the phase-locked loop unit is electrically connected with the filtering module, wherein the phase-locked loop unit receives the voltage signal from the filtering module, and the phase-locked loop unit correspondingly outputs a phase angle signal and a cosine signal.

14. The power conversion device according to claim 13, wherein the phase-locked loop unit comprises a first integrator, a coordinate transformation unit, a second proportional-integral regulator, a second integrator and a first calculating unit, wherein the voltage signal from the filtering module is converted into a set of orthogonal signals by the first integrator, and the set of the orthogonal signals are converted into a d-axis voltage signal and a q-axis voltage signal by the coordinate transformation unit according to the phase angle signal, wherein the second proportional-integral regulator receives the q-axis voltage signal and a second reference signal and correspondingly outputs a frequency offset, the second integrator receives the frequency offset and a nominal frequency and correspondingly outputs a phase angle signal, and the first calculating unit generates the cosine signal according to the phase angle signal, wherein an amplitude of the cosine signal is 1.

15. The power conversion device according to claim 14, wherein the current compensation module further comprises a current loop unit, and the current loop unit comprises a multiplier and a third proportional-integral regulator, which are electrically connected with each other in sequence, wherein the multiplier multiplies the cosine signal and the voltage compensation signal to obtain a current reference signal, and the third proportional-integral regulator receives the current reference signal and the inductor current and correspondingly outputs the current compensation signal.

16. The power conversion device according to claim 11, wherein the driving module comprises a modulation circuit and a driving circuit, wherein the modulation circuit is electrically connected with the current compensation module and the multi-stage high-frequency filter, and the modulation circuit receives the first control signal and correspondingly outputs a modulation signal, wherein the driving circuit is electrically connected with the modulation circuit and the switching circuit, and the driving circuit receives the modulation signal and correspondingly outputs the second control signal.

17. The power conversion device according to claim 11, wherein the power converter comprises a power factor correction circuit, and the power factor correction circuit comprises the first inductor and the switching circuit.

18. The power conversion device according to claim 11, wherein the multi-stage high-frequency filtering comprises a second-order generalized integrator.

19. The power conversion device according to claim 11, wherein the filtering module comprises a filtering capacitor.

20. The power conversion device according to claim 11, wherein the output terminal of the power converter is connected with a bus capacitor in parallel.
